(19) United States
(12) Patent Application Publication
(10) Pub. No.: US 2013/0232990 A1
(43) Pub. Date: Sep. 12, 2013

(54) Apparatus for Releasing a Flow Cross Section of a Gas Line

(71) Applicant: MAN DIESEL & TURBO SE, Augsburg (DE)

(72) Inventors: Martin Lenz, Augsburg (DE); Sascha Stoll, Ellgau (DE)

(73) Assignee: MAN Diesel & Turbo SE, Augsburg (DE)

(21) Appl. No.: 13/790,872

(22) Filed: Mar. 8, 2013

(30) Foreign Application Priority Data
Mar. 8, 2012 (DE) 10 2012 203 700.4

(51) Int. Cl. F02C 9/26

(52) U.S. Cl. CPC F02C 9/263
USPC 60/784

(57) ABSTRACT

An apparatus is described for the controlled release of a flow cross section of a gas line which is connected to a combustion chamber of a gas engine. The apparatus has a check valve and a flexible device. The flexible device is provided for absorbing a force occurring as a result of a thermal expansion of the check valve.

### BACKGROUND OF THE INVENTION

1. Field of the Invention

The present invention is directed to an apparatus for the controlled release of a flow cross section of a gas line which is connected to a combustion chamber of a gas engine. Further, the invention is also directed to a gas engine.

2. Description of the Related Art

Generally, a pressure-controlled check valve is installed in gas lines leading to a prechamber of a gas engine. When the pressure on the side of the check valve remote of the prechamber is greater than the pressure on the side facing the prechamber—this pressure essentially corresponds to the pressure in the prechamber—a pressure force resulting from the pressure differential holds the check valve open, usually against spring force. The flow cross section of the gas line is accordingly released and gas is conveyed into the prechamber.

If the force acting on the check valve, namely the sum of the spring force and pressure force exerted by the pressure in the prechamber, increases beyond the pressure force exerted by the supplied gas, the check valve closes and fluid is prevented from flowing back into the gas line. This situation occurs during the compression cycle of the gas engine; the compression pressure occurring in the main combustion chamber continues into the prechamber, and the check valve is closed by the pressing force taking place, a return flow into the gas line is prevented.

In a gas engine with a prechamber, the ignition of the gas mixture is initiated in the prechamber of the respective cylinder, and the propagating flame front also ignites the gas mixture in the main combustion chamber of the cylinder.

A check valve making up part of an injection system is known, for example, from British Published Patent Application 2 172 652.

In practice, ball valves are often used as check valves, wherein a ball arranged inside a bore is displaced against the action of a spring by a pressure force. Ball valves are constructed in a relatively simple manner and are inexpensive to produce. However, ball valves have the disadvantage that extensive wear occurs on the surfaces inside the bore which are struck by the ball due to effects of force. A ball valve which is improved with respect to this disadvantage is known from United States Published Patent Application No. 2003/0127140. The ball of the ball valve described in the cited document is guided in the bore in such a way that there are fewer unwanted movements due to clearance inside the bore, and therefore the ball and the surfaces inside the bore wear less quickly.

However, the ball valve which is disclosed in the above-cited document as well as other known check valves manifest considerable wear problems. This is particularly true of check valves used in gas engines because they are usually arranged directly adjacent to a combustion chamber and are therefore exposed to very high thermal stresses. Due to the very high temperatures prevailing in the vicinity of a combustion chamber, structural component parts such as a support body of the check valve expand during operation of the gas engine. To compensate for the thermal expansion, current check valves are often outfitted with a soft iron sealing ring which is provided for absorbing forces occurring as a result of the thermal expansion.

Soft iron sealing rings are plastically, and therefore irreversibly, deformed by the impinging forces. For this reason, they wear very quickly and must be replaced frequently. This means that the intervals between servicing of gas engines are also correspondingly short. Soft iron sealing rings are usually arranged deep in the prechamber of a gas engine. Therefore, in order to exchange a soft iron sealing ring of this kind the entire prechamber must be dismantled and then reinstalled. This makes it extremely expensive to replace a check valve or even only a soft iron sealing ring.

Further, another disadvantage of current check valves is that they become leaky very quickly, especially since a soft iron sealing ring wears very quickly. This in turn results in contamination and carbon deposits inside the gas line leading to a prechamber.

### SUMMARY OF THE INVENTION

Therefore, it is an object of the present invention to provide an apparatus for releasing the flow cross section of a gas line connected to the prechamber of a gas engine which is less prone to wear than the known apparatuses, requires less frequent maintenance or replacement and in which structural component parts to be replaced are easily accessible.

An apparatus according to the present invention for the controlled release of a flow cross section of a gas line connected to a combustion chamber of a gas engine has a check valve with a flexible device, wherein the flexible device is provided for absorbing a force occurring as a result of a thermal expansion of the check valve. By means of the apparatus, the flow cross section for the supply of gas into the combustion chamber, particularly the prechamber of a gas engine, is released and unblocked before combustion residues or gas can flow back into the gas supply line from the prechamber.

When the check valve is highly heated and thermal expansion occurs, the flexible device absorbs occurring forces in that an elastic deformation takes place. Therefore, it differs from common devices for absorbing forces occurring as a result of a thermal expansion of the check valve, i.e., by a soft iron sealing ring, for example, in that the deformation occurs elastically rather than plastically. Therefore, the deformation of the flexible device is reversible, and the flexible device is much less prone to wear. Therefore, an apparatus according to the invention must be serviced or replaced far less often than a prior art apparatus.

According to a further development of the apparatus according to the present invention, the flexible device is formed as a disk spring device. The disk spring device has one or more disk springs. Further, in case it has a plurality of disk springs, these disk springs are arranged, for example, in a spring set in the same direction. The disk spring or disk springs are so arranged that they bend, i.e., are compressed against spring force, during a thermal expansion of the check valve.

The preloading force of the disk spring device can be adjusted specifically to the compressive forces occurring during combustion; further, the maximum preloading force can be adapted to the maximum ignition pressures and/or the maximum peak pressures occurring during combustion in the combustion chamber. The advantage consists in that disk springs are elastically deformed, exhibit less wear, and with disk springs the spring stiffness can be exactly adapted to the respective gas engine.

The flexible device is preferably arranged on the side remote of the combustion chamber with respect to the check valve. Accordingly, the flexible device is installed farther away from the combustion chamber than the known soft iron ring.

Since the check valve is arranged between the flexible device and the combustion chamber, the flexible device is shielded from the combustion heat and is also accordingly less thermally stressed than the known soft iron sealing ring.

According to a further development of the present invention, the apparatus has a valve sleeve with a bore provided for the passage of gas, and the check valve and flexible device are arranged in the bore. In contrast to an apparatus according to the prior art, the check valve and the flexible device are arranged inside the valve sleeve. Replacing the valve sleeve as a complete package, particularly including check valve and flexible device, substantially facilitates servicing.

Further, according to a preferred embodiment, a locking screw by which the check valve can be detachably fastened in the valve sleeve is arranged in the valve sleeve, the flexible device being arranged between the locking screw and the check valve. For servicing, the locking screw can be loosened and the flexible device and/or the check valve can be pulled out of the valve sleeve, e.g., for replacement, if necessary, whereupon the aforementioned structural component parts can be fixed in the valve sleeve again by tightening the locking screw. Further, because the flexible device is arranged between the locking screw and the check valve, the flexible device can also be reached without having to pull the check valve out of the valve sleeve. Accordingly, servicing the aforementioned structural component parts is simplified compared to servicing the known apparatus with the soft iron sealing ring.

According to a preferred embodiment, the valve sleeve is detachably secured adjacent to the combustion chamber of the gas engine by a pressure screw. Further, the pressure screw is arranged outside of the valve sleeve and serves to secure the valve sleeve against the pressure forces built up in the combustion chamber. Whereas structural component parts such as a soft iron sealing ring and a check valve were integrated in the pressure screw in conventional apparatuses, the aforementioned structural component parts are now integrated in a valve sleeve and are more easily accessible.

According to a preferred embodiment, a spacer sleeve is arranged between the flexible device and the check valve. This spacer sleeve performs the function of a spacer between the check valve and the flexible device and thus provides for reduced thermal stressing of the flexible device.

Further, a diaphragm is preferably arranged between the spacer sleeve and the flexible device, the through-bore of this diaphragm can have different diameters so that the mass flow of gas passing through per time unit can easily be varied by using a diaphragm with a passage corresponding to the requirements specification of the cylinder that is supplied with gas. In this way, the apparatus according to the invention can be adapted to different gas engines.

Depending upon piston displacement, the opening cross section of the diaphragm can be increased or reduced, for example, so that more of less gas can reach the combustion chamber per time unit. The advantage consists in that large piece numbers of the apparatus according to the invention can be produced in standardized dimensions and can then be used in conjunction with different engines. Therefore, the apparatus according to the invention can be produced economically.

The invention likewise includes a gas engine with at least one prechamber, wherein an apparatus according to the invention is arranged in a gas line connected to the prechamber. Of course, in a gas engine having a plurality of prechambers, apparatuses according to the invention can also be arranged in a plurality of gas lines which are connected respectively to a prechamber.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a sectional view of an embodiment form of an apparatus according to the invention;

FIG. 2 shows an exploded view of a section of an apparatus according to the prior art in disassembled condition; and

FIG. 3 shows a schematic diagram of a gas engine with an installed apparatus according to the invention.

### DETAILED DESCRIPTION OF THE PRESENTLY PREFERRED EMBODIMENTS

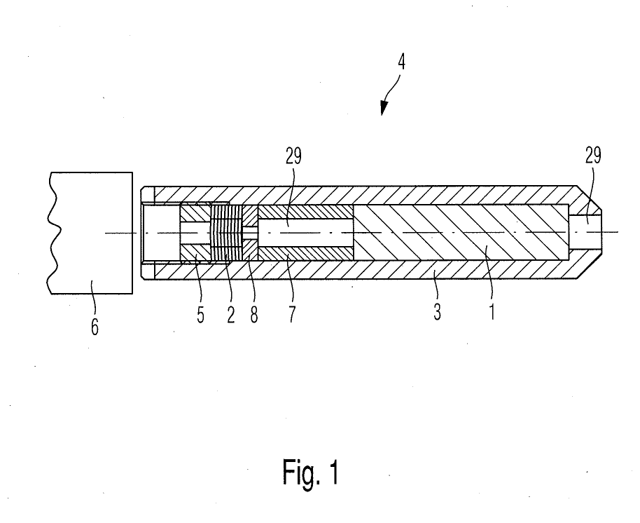

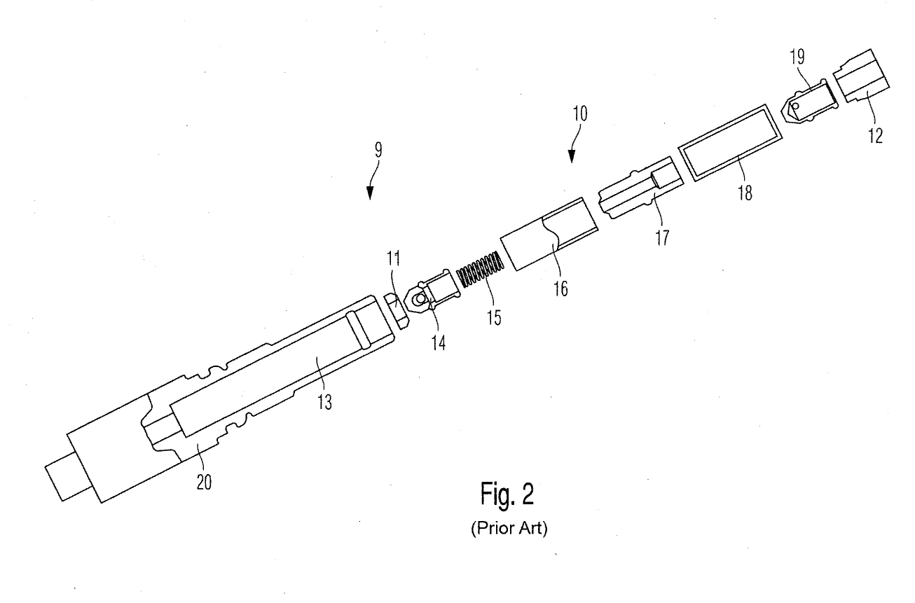

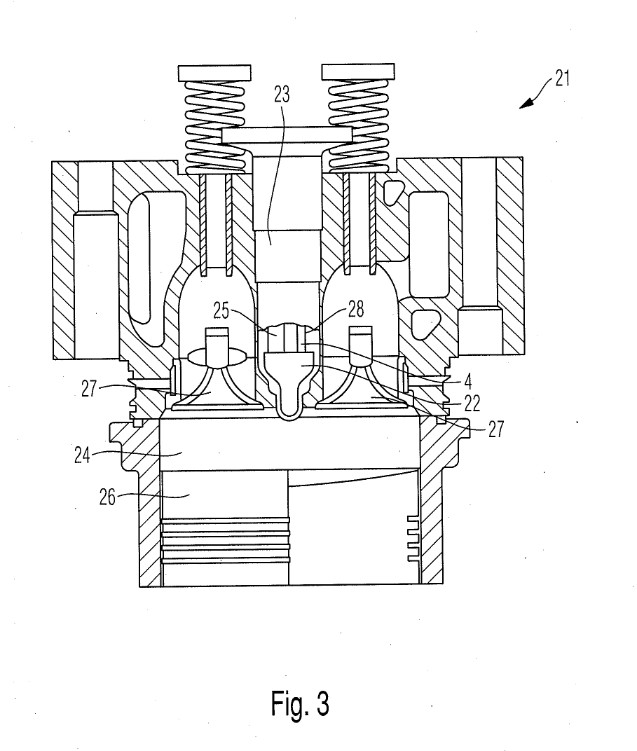

FIG. 1 shows a sectional view of an embodiment form of an apparatus 4 according to the present invention for releasing the flow cross section of a gas line 28 shown in FIG. 3. For purposes of comparison, FIG. 2 also shows an exploded view of a prior art apparatus 9. The apparatus 4 according to the invention will be described first.

The apparatus 4 shown in FIG. 1 has a check valve 1 which is arranged in the front portion of the valve sleeve 3, i.e., on the right-hand side referring to FIG. 1. A bore 29 through which gas can flow extends through the entire valve sleeve 3. The check valve allows passage in one direction—from left to right in the figure—namely, in the direction of the combustion chamber 24 shown in FIG. 3 and a prechamber 22, but not in the other direction, i.e., from right to left in the figure.

Due to the fact that the check valve 1, as can be seen in FIG. 3, is located directly adjacent to the prechamber 22 which is highly heated during operation of the gas engine 21, it is exposed to high thermal stresses. It expands due to the effect of heat. The apparatus 4 according to the present invention has disk springs 2 which absorb the force resulting from a longitudinal expansion of the check valve 1 and acting toward the left-hand side with reference to the figure by compressing counter to the spring force. The spring force of the disk springs 2 which are arranged to form a spring set in the same direction is specifically configured to the forces occurring due to the longitudinal expansion of the check valve 1.

A spacer sleeve 7 and a diaphragm 8 are arranged between the disk springs 2 and the check valve 1. The distance between the prechamber and the spring set is increased by the spacer sleeve 7 so that the thermal stress on the disk springs 2 is reduced.

The gas supply pressure and the mass flow of gas can be adjusted with the diaphragm 8. The opening cross section of the diaphragm 8 is specifically adapted to the particular gas engine 21 which is shown partially in FIG. 3. The opening cross section is configured to allow a quantity of gas to flow that corresponds to the capacity of the supplied cylinder of the gas engine 21.

The check valve 1, disk springs 2, spacer sleeve 7 and diaphragm 8 are detachably secured in the valve sleeve 3 by the locking screw 5. When the locking screw 5 is loosened, the disk springs 2 can be pulled out first of all and, if necessary, replaced. This correspondingly simplifies servicing of the apparatus 4.

The entire valve sleeve 3 is detachably secured adjacent to the prechamber 22 shown in FIG. 3 by a pressure screw 6. The pressure screw 6 is configured to hold the valve sleeve 3 in position even when high pressures act on it from the prechamber 22. It is advantageous that the above-mentioned functional components cooperating with the check valve 1 are arranged in one and the same valve sleeve 3, but outside of the pressure screw 6. When the pressure screw 6 is loosened, the valve sleeve 3 can be pulled out in its entirety and, if necessary, replaced likewise in its entirety.

The apparatus 4 according to the invention differs from a prior art apparatus 9 in most of the particulars mentioned above. This prior art apparatus 9 is shown in an exploded sectional view in FIG. 2 for the sake of comparison.

The check valve 10 and other structural component parts of the apparatus 9 cooperating with the check valve 10 are all installed together in a pressure screw 20 in the installed condition. In the known apparatus 9, the interior space 13 of the pressure screw 20 serves to receive the structural component parts shown in the exploded view. These structural component parts are shown in section in the figure to the right of the interior space 13 in the corresponding sequence in which they are installed.

The structural component part which is positioned at the lowest point of the pressure screw 20 in the installed condition is a soft iron sealing ring 11. This soft iron sealing ring 11 serves to absorb forces resulting from thermal longitudinal expansions of the check valve 10 and to permit longitudinal compensation. However, because of the force occurring here, the soft iron sealing ring 11 deforms plastically rather than elastically and is therefore exposed to much greater wear than the disk springs 2 in the apparatus 4 according to the invention.

The check valve 10 in the illustrated apparatus 9 particularly comprises a ball valve 14, a valve spring 15, a sleeve 16 and a valve body 17 with a bore for the passage of gas. When gas flows toward a combustion chamber, not shown in more detail, the ball is displaced opposite to the spring force of the valve spring 15 due to the pressure force of the gas, and the aperture of the ball valve 14 is released for gas to flow through. When the gas pressure correspondingly increases in the prechamber, not shown in more detail, and gas starts to flow back—from right to left in the figure—the pressure force acting on the ball can no longer compensate for the opposing spring force of the compressed valve spring 15, and the ball is pushed back over the aperture of the ball valve 14. Accordingly, no combustion products and no compressed fuel gas can flow back from the combustion chamber into the gas feed line.

Adjacent to the check valve 10, a spacer 18 and a sealing plug 19 are installed in the interior 13 of the pressure screw 20. The aforementioned structural component parts are secured inside the pressure screw 20 by a locking screw 12. Accordingly, in contrast to the construction of the apparatus 4 according to the present invention, all of the structural component parts (with the exception of the pressure screw 20 itself) are installed in a pressure screw in the apparatus 9 according to the prior art.

Since the soft iron sealing ring 11 has very high wear, it must be replaced very often. In this connection, it has proven disadvantageous for servicing a gas engine with an apparatus 9 according to the prior art that the soft iron sealing ring 11 is located at the lowest and therefore least accessible point in the pressure screw 20.

In the apparatus according to the invention, disk springs 2 are installed instead of a soft iron sealing ring 11. These disk springs 2 are not only less prone to wear but are also installed at a quickly accessible location, namely, in the front of the valve sleeve 3. Servicing of a gas engine 21 outfitted with an apparatus 4 according to the invention is therefore substantially simpler to carry out.

FIG. 3 shows a partial region of a gas engine 21 outfitted with an apparatus 4 according to the invention. The apparatus 4 is located in a gas line 28 which leads to the prechamber 22. A main combustion chamber 24 with a piston 26 is arranged adjacent to the prechamber 22. Further, a spark plug 25 and a prechamber holder 23 are shown above the prechamber 22, and valves 27 of the gas engine 21 are located on both sides of the prechamber 22. The check valve 1 ensures that no combustion products from the prechamber and no fuel gas compressed during the compression stroke of the piston 26 can flow back into the gas line 28.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We I claim:

1. An apparatus for a controlled release of a flow cross section of a gas line connected to a combustion chamber of a gas engine, comprising:
a check valve; and
a flexible device for absorbing a force occurring as a result of a thermal expansion of the check valve.

2. The apparatus according to claim 1, wherein the flexible device includes a disk spring device.

3. The apparatus according to claim 1, wherein the flexible device is arranged on a side remote from the combustion chamber with respect to the check valve.

4. The apparatus according to claim 1, further comprising:
a valve sleeve including a bore, wherein the check valve and the flexible device are arranged in the bore.

5. The apparatus according to claim 4, further comprising:
a locking screw arranged in the valve sleeve and by which the check valve is detachably fastened in the valve sleeve; wherein the flexible device is arranged between the locking screw and the check valve.

6. The apparatus according to claim 4, further comprising:
a pressure screw for detachably securing the valve sleeve adjacent to the combustion chamber.

7. The apparatus according to claim 1, further comprising:
a spacer sleeve arranged between the flexible device and the check valve.

8. The apparatus according to claim 7, further comprising:
a diaphragm arranged between the flexible device and the spacer sleeve.

9. A gas engine system, comprising:
a gas engine including at least one prechamber; and
an apparatus according to claim 1 and arranged in a gas line connected to the prechamber.
